(19) United States
(12) Patent Application Publication
(10) Pub. No.: US 2012/0283093 A1
(43) Pub. Date: Nov. 8, 2012

(54) PERMEABLE MATRIX ALLOWING ADSORPTION AND CAPTURE OF CO2 BY MEANS OF CARBONIOUS MATERIAL AND A COOLING SYSTEM INDEPENDENT OF EXTERNAL ENERGY SOURCES

(76) Inventors: Marco Mastrodonato, Milano (IT); Massimo Prati, Saronno (IT); Ioana Veronica Micu, Paderno Dugnano (IT)

(21) Appl. No.: 13/510,157

(22) PCT Filed: Nov. 16, 2010
(86) PCT No.: PCT/EP2010/006949

§ 371 Date: Jul. 23, 2012

(30) Foreign Application Priority Data
Nov. 17, 2009 (IT) MI2009A002022

(51) Int. Cl. B01J 20/22; B23P 17/04; B65B 3/04; F25D 31/00; F25D 3/00; B65B 63/08

(52) U.S. Cl. 502/404; 62/452; 53/440; 141/1; 62/56; 29/592

(57) ABSTRACT

Disclosed is a material capable of adsorbing carbon dioxide which is obtainable by compressing a mixture of a carbonious material selected from fossil carbons and/or graphite and a solid binder consisting of a disaccharide or glucose in powder form.

This invention relates to a material capable of adsorbing carbon dioxide which is obtainable by isostatic compression of a mixture of a carbonious material selected from fossil carbon and/or graphite and a binder.

### BACKGROUND TO THE INVENTION

The problem of maintaining cold conditions for sanitary, food and similar applications is particularly felt, and a variety of solutions have been proposed.

Containers which contain materials that accumulate cold such as aqueous solutions of inorganic salts (calcium chloride, sodium chloride) or of glycols are known in particular, and have long been used. Said containers are cooled, typically by placing them in a freezer or refrigerator, and then placed in contact with the articles to be cooled or stored, or inserted into cooler bags in which they ensure low temperatures for several hours. Examples of said containers are described in U.S. Pat. No. 2,061,427 and U.S. Pat. No. 5,557,943.

WO 02/25190 discloses a composition for transferring heat to or from fluids consisting of activated carbon, graphite and a synthetic polymer (poly tertafluoro ethylene) as a binder. Carbon dioxide in gas form is absorbed onto the surface of the material. A short term cooling effect is obtained by the release of the carbon dioxide from the material upon opening the container in which it is stored. The effect may be useful for short term cooling needs, for instance for chilling canned or bottled drinks. Long term cooling is not possible since only limited amount of gaseous carbon dioxide is absorbed on the surface only of the material.

At present, no reproducible material exists which is able to adsorb carbon dioxide in any state, particularly in the liquid state.

### DESCRIPTION OF THE INVENTION

A material has now been found which, when treated under suitable conditions with liquid carbon dioxide in supercritical conditions, is capable of accumulating cold for very long periods, far more efficiently than the conventional materials used to date.

Said material is also able to adsorb large volumes of carbon dioxide, and can therefore also be used for the storage of said gas, an environmental problem which is particularly felt in view of the “greenhouse gas” problem.

The invention also relates to double-wall cooling containers wherein the material according to the invention, treated with liquid carbon dioxide, is placed in the cavity formed in the double wall of the container. The containers according to the invention can be used in a wide variety of household and industrial applications, such as storage of drugs, cosmetics, foods, medical devices, medical/surgical supplies, biological materials (such as tissues or organs for transplantation, cells and micro-organisms) and for cryogenic storage in general.

The containers according to the invention, suitably shaped and dimensioned, can also be used for insulation and cooling in the construction and other industries. Another possible application is the manufacture of cutting tools, because when the material in question is subjected to a number of consecutive adsorption cycles, it reaches considerable hardness values.

### DETAILED DESCRIPTION OF THE INVENTION

The material to which the invention relates is obtainable by compressing a mixture of a carbonious material selected from fossil carbon and/or graphite and a suitable organic binder of natural origin selected from a disaccharide or glucose in powder form.

The carbonious material may be wood, peat, lignite, bituminous coal, anthracite or graphite, preferably anthracite.

The carbonious material, in particular anthracite, preferably has a inhomogeneous grain size with particles of dimensions ranging between 1 micron and 7 mm, with variable, irregular particle shapes. Said particle size can be obtained by grinding with conventional equipment and techniques.

The particle size of the carbonious powder can be measured with conventional instruments, based on a sieve assay.

The disaccharide is preferably sucrose or fructose, optionally in micronised form.

The carbonious material and the binder are mixed in conventional roller, blade or screw mixers at low speed, avoiding the formation of agglomerates.

The weight ratio between the carbonious material and the disaccharide binder is between 1:100 and 100:1, preferably between 15:1 and 18:1 if given characteristics are to be obtained.

The carbonious material and the disaccharide binder or glucose are assayed with conventional volumetric analysis systems, such as those equipped with strips and plates, balancing strips, slide-valves and balances or the like.

The mixture then undergoes cold isostatic compression, pressure being applied evenly in all directions so as to obtain a product with uniform density.

The homogenous mixture, the specific gravity of which is typically approx. 1.20 kg/dm³, can be distributed between steel moulds or latex, PVC or rubber bags which have the geometrical shape of the desired semi-manufactured product, taking care to distribute it evenly in the mould.

The material thus obtained is able to adsorb large volumes of carbon dioxide in a substantially irreversible way, and can be advantageously used for the storage of said gas.

The cooling and cold accumulating material is obtained by immersing the materials obtained as described above in liquid CO₂ in a scrupulously clean, dry hyperbaric tank.

The tank or cryostat can be made of AISI 304 stainless steel or the like, suitable for use with pressure vessels at low temperatures, fitted with liquid CO₂ filling valve(s), gas relief valve(s), pressure gauges, safety valve(s) dimensioned on the basis of the unit, liquid carbon dioxide discharge and recovery valve(s), cooling coil, refrigerator unit and control devices.

The time spent by the compressed material in the cryostat is at least 15 min per kg of material at an operating pressure of not less than 20 bars after the filling stage. When absorption is complete, the cryostat is depressurised by opening the gas relief valve or discharging the liquid carbon dioxide into cylinders and opening the valves.

In the cryostat the anhydride passes from the liquid state to the solid state, and the temperature falls to approx. −70° C. and the solid state will remain trapped in the porosity

The proportioning of the quantity of material and carbon dioxide depends on the volume and temperature characteristics to be obtained. For example, approx. 50 g of material obtained by mixing approx. 45 g of anthracite and approx. 5 g of micronised sugar is required to maintain a temperature of between 2° C. and 8° C. in a volume of 20 ml. Said material is maintained at a pressure of 20 bars in the cryostat for 20 min until a final temperature of approx. −70° C. has been reached in the cryostat.

The material according to the invention thus obtained can be introduced into the cavity formed by double walls of containers, made of suitable materials; the double walls dimensions increase in proportion to the dimensions of the receptacle. The material thus inserted into the receptacle will then be subjected to a pressure which, in the specific case described in the example above, will be between 2 and 5 bars.

The containers according to the invention use the principle of a Dewar vessel and can be made of steel, Ni steel, plastic or non-ferrous metal resistant to low temperatures, classified according to standard UNI EN 129, preferably Ni steel of good tenacity used for cryogenic applications.

The lid of the container is fitted with inner pressure control devices, for example a valve such as a ball valve which can be regulated in the closed and open positions.

The invention is illustrated in further details by the following examples.

### EXAMPLE 1

A mixture of 0.93 Kg of anthracite and 0.13 Kg of sucrose was subjected to isostatic cold pressing at a pressure of 2000 bar. Molds having a diameter of 110 mm, 230 mm thick were obtained. The specific weight was 1.20 Kg/dm³.

### EXAMPLE 2

A mixture of 1.58 Kg of anthracite and 0.22 Kg of sucrose was subjected to isostatic cold pressing at a pressure of 1850 bar. Molds having a diameter of 110 mm, 230 mm thick were obtained.

### EXAMPLE 3

The molds of examples 1 and 2 were placed in a cryostat into which liquid carbon dioxide was fed. The absorption was continued for 15 minutes at a pressure ranging from 10 to 30 bars. The cryostat was then opened, the dry ice in excess was mechanically separated and a matrix having a grid-like surface was obtained and tested for weight of absorbed carbon dioxide and sublimation time.

The results are reported in the Following Table

TABLE

| | Initial | Final | Final | sublimation | matrix Co2 | comparison | sublimation | prolonged |
|---|---|---|---|---|---|---|---|---|
| | matrix | matrix | Matrix Co2 | time of Co2 | sublimation | between free | time of Co2 | Co2 |
| | weight | weight | Absorbed | solid phase | (experimental 0.120 | and matrix for | solid phase for | sublimation |
| Example | (kg) | (kg) | (kg) | (hrs) | kg/7 hrs) (hrs) | 4 kg Co2 (hrs) | 4 kg (hrs) | time (hrs) |
| 1 | 1.04 | 1.16 | 0.12 | 0.72 | 7.00 | 233.33 | 24.00 | 209.33 |
| 2 | 1.17 | 1.27 | 0.10 | 0.60 | 5.83 | 233.33 | 24.00 | 209.33 |

1. A material capable of adsorbing carbon dioxide obtainable by compressing a mixture of fossil carbons and/or graphite and a solid binder consisting of disaccharide or glucose in powder form.

2. Material as claimed in claim 1, wherein the carbonious material is anthracite.

3. Material as claimed in claim 2, wherein the disaccharide is saccharose in solid state.

4. Material as claimed in claim 2, wherein the anthracite has a heterogeneous particle size with particles of dimensions ranging between 1 micron and 7 mm.

5. A material as claimed in claim 1, treated by immersion in carbon dioxide in the liquid state.

6. Double-wall cooling containers wherein the material claimed in claim 5 is introduced into the cavity formed in the double wall of the container.

7. Containers as claimed in claim 6, with ball valves or other inner pressure control devices.

8. Containers as claimed in claim 6, wherein the double chamber is made of steel, plastic or non-ferrous metal.

9. A method for storing drugs, cosmetics, foods, medical devices, medical/surgical supplies and human organs with the containers claimed in claim 6.

10. Method for insulation and storage in the construction and other industries with the container claimed in claim 6.

11. Method for the storage of carbon dioxide with the container claimed in claim 1.

12. Method for manufacturing cutting tools with the material claimed in claim 5.

13. Method for cooling in the construction and other industries with the material claimed in claim 5.
